(19) United States
(12) Patent Application Publication
(10) Pub. No.: US 2012/0082596 A1
(43) Pub. Date: Apr. 5, 2012

(54) Reactor for Moisture Generation

(75) Inventors: Tadahiro OHMI, Miyagi (JP); Koji KAWADA, Osaka (JP); Nobukazu IKEDA, Osaka (JP); Akihiro MORIMOTO, Osaka (JP); Yukio MINAMI, Osaka (JP); Keiji HIRAO, Osaka (JP); Shinji SAKAMOTO, Osaka (JP); Masafumi KITANO, Osaka (JP)

(73) Assignees: FUJIKIN INCORPORATED, Osaka (JP); TOHOKU UNIVERSITY, Miyagi (JP)

(21) Appl. No.: 13/274,446

(22) Filed: Oct. 17, 2011

Related U.S. Application Data
(63) Continuation-in-part of application No. PCT/JP2010/002914, filed on Apr. 22, 2010.

(30) Foreign Application Priority Data
Apr. 24, 2009 (JP) 2009-107139

(51) Int. Cl. B01J 12/00

(52) U.S. Cl. 422/241

(57) ABSTRACT

A reactor for moisture generation generates high-purity moisture at a catalytic reaction temperature that is lower than an ignition point of hydrogen gas and oxygen gas so hydrogen and oxygen gas are supplied into the reactor having a platinum catalyst layer to catalyze the reaction of the gases without combustion, wherein the reactor maintains high adhesion strength for a long time of the platinum catalyst layer to a barrier layer provided between the base material and the platinum catalyst layer. The reactor includes a reactor main body that has a gas inlet and a moisture outlet, and the Y₂O₃ barrier layer is formed on at least a part of an internal wall surface of the reactor main body, and the platinum catalyst layer is formed on at least a part of the Y₂O₃ barrier layer. A film thickness of the Y₂O₃ barrier layer is preferably 50 nm to 5 μm.

This is a Continuation-in-Part Application in the United States of International Patent Application No. PCT/JP2010/002914 filed Apr. 22, 2010, which claims priority on Japanese Patent Application No. 2009-107139, filed Apr. 24, 2009. The entire disclosures of the above patent applications are hereby incorporated by reference.

### TECHNICAL FIELD OF THE INVENTION

The present invention relates to a reactor for moisture generation in which high-purity moisture is generated at a catalytic reaction temperature (i.e., 400° C. or less) that is lower than an ignition point of hydrogen gas and oxygen gas (i.e., 500 to 580° C.), without combustion (approximately 2000° C.) by supplying hydrogen gas and oxygen gas into the reactor that has a platinum catalyst layer to catalyze the reaction of the gases.

### BACKGROUND ART

### Background of the Invention

Conventionally, a reactor for moisture generation is known that is used for continuously supplying ultra-pure moisture in oxide filming of silicon using a moisture oxidation method in semiconductor manufacturing (for example, as disclosed in Patent Documents 1 to 5).

This kind of reactor for moisture generation is, as shown in FIG. 4, for example, formed such that reactor main body members 22 and 23 are combined and welded together, so as to face each other, in order to form a reactor main body having an internal space P for reaction. The reactor for moisture generation also includes a raw material gas inlet 24, a moisture gas outlet 25, an inlet side reflector 26, an outlet side reflector 27, and the like, which are respectively provided in the reactor main body, and a platinum catalyst layer 28b is provided on an internal wall surface of the reactor main body member 23 on a side facing the raw material gas inlet 24. As shown in FIG. 4, the reflectors are fixed to the reactor main body via spacers 31 with fixation screws 30.

A barrier layer 28a is formed between a stainless-steel base material of the reactor and the platinum catalyst layer 28b, and the barrier layer 28a inhibits impurities in the base material from diffusing in the platinum catalyst layer 28b, which prevents degradation of the platinum catalyst layer.

A thickness of the barrier layer 28a is approximately 0.1 μm to 5 μm, and, for example, the barrier layer 28a is made of TiN and is formed by an ion plating method. Moreover, a thickness of the platinum catalyst layer 28b is approximately 1 nm to 0.5 mm, and is formed by, for example, a vacuum deposition method. In addition, as the method for forming the barrier layer 28a, in addition to the ion plating method, a PVD method, such as an ion sputtering method or a vacuum deposition method, or a chemical vapor deposition method (CVD method), or a hot-pressing method, or a thermal spraying technique, or the like, may be used. Furthermore, as the method for forming the platinum catalyst layer 28b, in addition to the vacuum deposition method, an ion plating method, or an ion sputtering method, or a chemical vapor deposition method, or a hot-pressing method, or the like, may be used, and moreover, a plating method as well may be used when the barrier layer 28a is a conductive substance such as TiN.

### PRIOR ART DOCUMENTS

### Patent Documents

Patent Document 1: International Publication WO 97/28085,

Patent Document 2: Japanese Published Unexamined Patent Application No. 2000-169108,

Patent Document 3: Japanese Published Unexamined Patent Application No. 2000-169109,

Patent Document 4: Japanese Published Unexamined Patent Application No. 2000-169110, and

Patent Document 5: Japanese Published Unexamined Patent Application No. 2002-274812.

### PROBLEMS TO BE SOLVED BY THE INVENTION

However, there has been the problem that adhesion strength (e.g., peel strength) of a platinum catalyst layer to a barrier layer is deteriorated when a conventional barrier layer made of TiN, or the like, is used for a long period of time.

Such deterioration with time in adhesion strength is attributed to deterioration in adhesion strength between the barrier layer and the platinum catalyst layer by activated oxygen (i.e., oxygen radicals) due to a catalytic reaction that passes through the platinum catalyst layer to gradually oxidize the vicinity of the interface between the barrier layer and the platinum catalyst layer.

Such deterioration in adhesion strength is not as bad as the platinum catalyst layer being peeled off during normal use. However, the platinum catalyst layer may be partially peeled off by, for example, unanticipated impact, or the like, on the reactor for moisture generation by unintended falling, or the like, during maintenance.

When the platinum catalyst layer is peeled off, the peeled platinum becomes contaminated, which has significant harmful effects on the quality of semiconductors to be manufactured.

Furthermore, when the platinum catalyst layer is peeled off, the peeled platinum has a small heat capacity, and its temperature is increased due to reaction heat generated by a catalytic reaction between hydrogen gas and oxygen gas, which may become an ignition source. This ignition source brings about damage to manufacturing devices and raises safety issues from explosion and combustion.

Therefore, an object of the present invention is to provide a reactor for moisture generation that is capable of maintaining high adhesion strength of the platinum catalyst layer to the barrier layer for a long period of time.

### SUMMARY OF THE INVENTION

### Means for Solving the Problems

As a result of intensive studies, the inventors have found that a platinum catalyst layer is capable of maintaining high adhesion strength to the barrier layer for a long period of time by forming a barrier layer of Y₂O₃.

Accordingly, in order to achieve the object of the present invention, the present invention provides a reactor for moisture generation that includes a reactor main body in which a gas inlet and a moisture outlet are provided, a Y₂O₃ barrier layer that is formed on at least a part or portion of an internal wall surface of the reactor main body, and a platinum catalyst layer formed on at least a part or portion of the Y₂O₃ barrier layer.

A film thickness of the Y₂O₃ barrier layer is preferably 50 nm to 5 μm, and is more preferably 100 to 300 nm.

The reactor main body is preferably formed of a material that is catalytically inactive to hydrogen and oxygen.

The reactor for moisture generation further includes at least one reflector inside the reactor main body, and the reflector is preferably formed of a material that is catalytically inactive to hydrogen and oxygen.

The reflector is fixed to the reactor main body via spacers with fixation screws so as to block up at least one of the gas inlet and the moisture outlet via a predetermined space, and the spacers and the fixation screws are preferably formed of a material that is catalytically inactive to hydrogen and oxygen.

A material, which is catalytically inactive to hydrogen and oxygen, is preferably used for members such as reactor main body members and reflectors having surfaces exposed to gas inside the reactor.

The material, which is catalytically inactive, is preferably an iron-chromium-aluminum alloy, an aluminum alloy, or a copper alloy.

An area of the reactor main body, other than the portion on which the platinum catalyst layer is provided inside an internal space, is preferably coated with a barrier layer formed of a material that is catalytically inactive to hydrogen and oxygen.

Moreover, the reactor for moisture generation further includes at least one reflector disposed inside the reactor main body, and the reflector is preferably coated with a barrier layer formed of a material that is catalytically inactive to hydrogen and oxygen.

Furthermore, the reflector is fixed to the reactor main body via spacers with fixation screws so as to block up at least one of the gas inlet and the moisture outlet via a predetermined space, and the spacers and the fixation screws are preferably coated with a barrier layer formed of a material that is catalytically inactive to hydrogen and oxygen.

The barrier layer formed of the material that is catalytically inactive is preferably formed of at least one material selected from the group consisting of TiN, TiC, TiCN, TiAlN, Al₂O₃, Cr₂O₃, SiO₂, CrN, and Y₂O₃.

### EFFECT OF THE INVENTION

In accordance with the present invention, a Y₂O₃ barrier layer is formed on an internal wall surface of a reactor main body, and a platinum catalyst layer is formed on the Y₂O₃ barrier layer, which makes it possible to inhibit deterioration with time in adhesion strength of the platinum catalyst layer to the Y₂O₃ barrier layer.

### BRIEF DESCRIPTION OF THE DRAWINGS

FIG. 1 is a graph showing test results of adhesion strength of a platinum catalyst layer to a Y₂O₃ barrier layer with respect to Examples 1 and 2 of the present invention.

FIG. 2 is a graph showing test results of adhesion strength of the platinum catalyst layer to the Y₂O₃ barrier layer with respect to Examples 3 and 4 of the present invention.

FIG. 3 is a graph showing a test result of adhesion strength of the platinum catalyst layer to a TiN barrier layer with respect to a comparative example.

FIG. 4 is a longitudinal cross-sectional view showing one embodiment of a conventional reactor for moisture generation.

FIG. 5 is a longitudinal cross-sectional view showing an embodiment of a reactor for moisture generation in accordance with the present invention.

### MODE FOR CARRYING OUT THE INVENTION

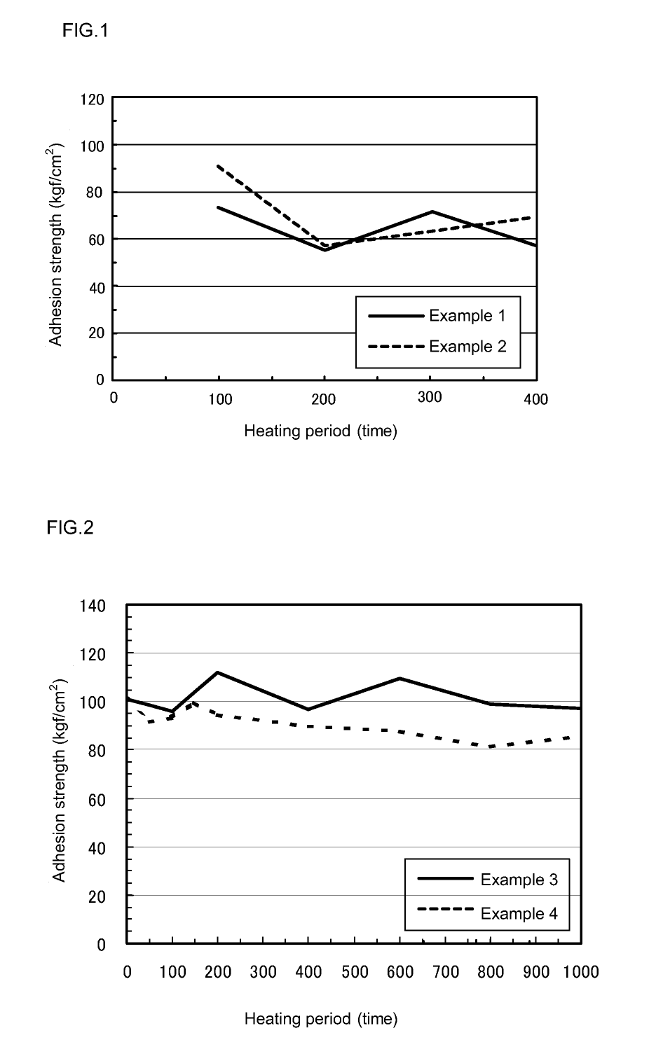

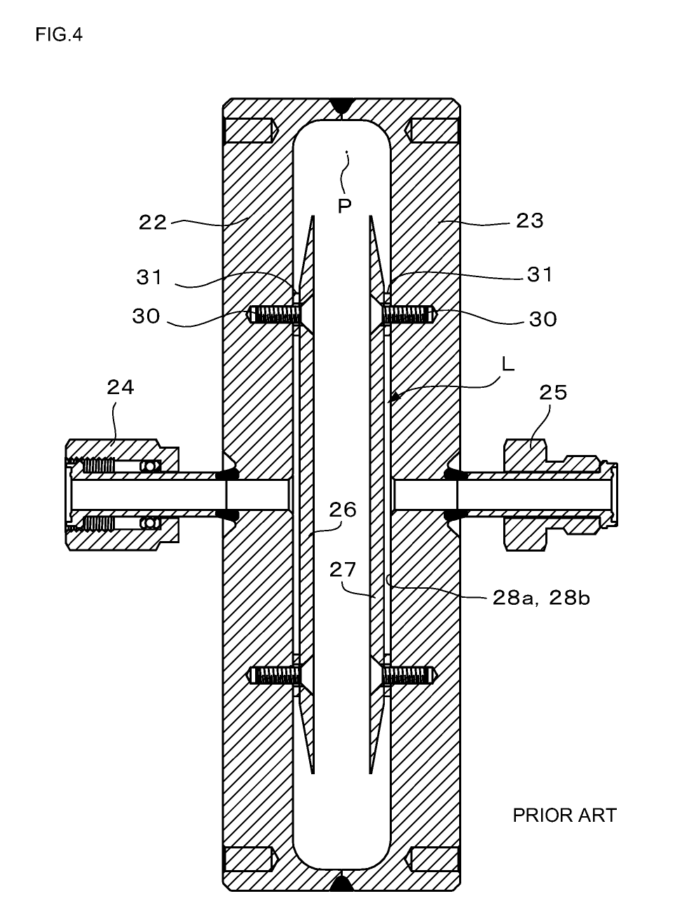

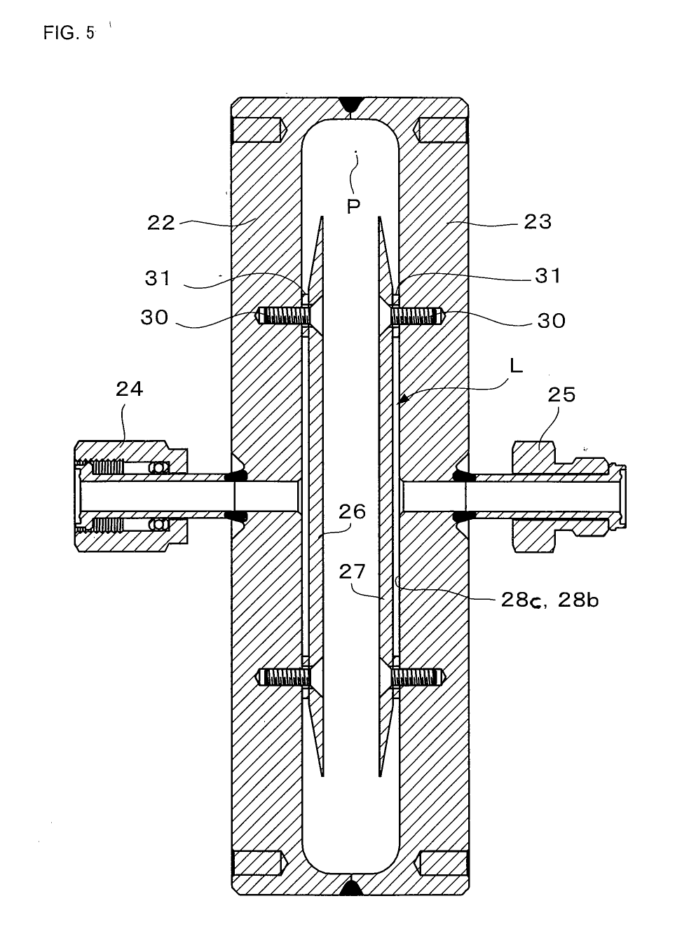

An embodiment of a reactor for moisture generation according to the present invention will be hereinafter described with reference to FIGS. 1 to 3 and 5. Because the structure of the reactor for moisture generation, in accordance with the present invention, is essentially the same as that of the conventional art, except for the point that the barrier layer 28a is made of Y₂O₃, the description thereof will be given with reference to FIG. 5, wherein like parts are designated by like character references with respect to FIG. 4.

In the reactor for moisture generation of FIG. 5, a Y₂O₃ barrier layer 28c is formed on an internal wall surface of a reactor main body member 23 on the outlet side, and a platinum catalyst layer 28b is formed on the Y₂O₃ barrier layer 28c. The Y₂O₃ barrier layer 28c is a barrier layer that inhibits impurities in the base material of the reactor main body member 23 from diffusing inside the platinum catalyst layer 28b. In the same way as the reactor main body member 23 on the outlet side, a Y₂O₃ barrier layer 28c may be formed on an internal wall surface of a reactor main body member 22 on the inlet side, and a platinum catalyst layer 28b may be formed on the Y₂O₃ barrier layer 28c. However, when a reaction to generate moisture is actively induced in the vicinity of the inlet of a raw material gas inlet 24, the temperature of an inlet side splicing fitting, or the like, may be increased too high. Therefore, a platinum catalyst layer is preferably not formed at least within a 10 mm radius from the center of the raw material gas inlet 24 of the reactor main body member 22 on the inlet side, and is more preferably not formed within a 15 to 25 mm radius.

As a base material of the reactor main body, for example, stainless steel, such as SUS316L, nickel alloy steel, or nickel steel, may be used. In the case where the reactor main body is formed of a material, such as stainless steel, nickel alloy steel, or nickel steel, which is catalytically active to O₂ or H₂, it is particularly preferable that, for the portion where the platinum catalyst layer is not formed inside the reactor, a noncatalytic barrier layer, which is catalytically inactive to oxygen and hydrogen, is formed as a barrier layer for preventing catalytic activity by the base material. As such a material of the barrier layer, TiN, TiC, TiCN, TiAlN, Al₂O₃, Cr₂O₃, SiO₂, or CrN may be used, and Y₂O₃ as well may be used. In addition, two or more types of those among these materials listed may be used.

This is the same as for the reflectors 26 and 27 in the case where reflectors 26 and 27 are provided in the reactor main body. That is, in the case where the base material of the reflectors 26 and 27 is a material that is catalytically active to O₂ or H₂, a noncatalytic barrier layer that is catalytically inactive to oxygen and hydrogen is preferably formed on the reflectors 26 and 27.

In addition, in the case where Y₂O₃ is used as a barrier layer for preventing catalytic activity by the base material, the barrier layer may be used in common as the barrier layer that inhibits impurities in the base material from diffusing inside the platinum catalyst layer 28b. That is, after the barrier layer 28c of Y₂O₃ is formed on the entire internal surface of the reactor main body members 22 and 23, the platinum catalyst layer 28b may be formed only on a desired portion on the barrier layer.

The reflectors 26 and 27 may be disposed so as to face each other inside the reactor. The reflectors 26 and 27 are formed to be discoid in the example illustrated. However, the shapes of the reflectors 26 and 27 are not limited as long as the shapes thereof are capable of improving the efficiency of diffusing mixed gas by colliding with mixed gas flowing into an internal space P of the reactor. The inlet side reflector 26 is fixed to the reactor main body member 22 via spacers 31 with fixation screws 30 so as to block up the raw material gas inlet 24 via a given gap from the reactor main body member 22 on the inlet side. The outlet side reflector 27 as well is fixed to the reactor main body member 23 via the spacers 31 with the fixation screws 30 so as to block up the moisture gas inlet 25 via a given gap from the reactor main body member 23 on the outlet side. The reflectors may be fixed not only by screw clamps, but also by another fixing means such as by welding. In addition, the example illustrated shows the example provided with the pair of reflectors. However, one reflector may be provided, and in that case, it is preferable that only the outlet side reflector 27 may be provided.

A mixed gas G jetted toward the reflector 26 through the raw material gas inlet 24 collides with the reflector 26 to be diffused inside the internal space P, and the diffused mixed gas G makes contact to roughly evenly collide over the entire surface of the platinum catalyst layer 28b, to be so-called “catalytically activated,” which induces a reaction of H₂ and O₂ to generate moisture gas. Furthermore, the moisture gas formed inside the internal space P is guided out to the moisture gas outlet 25 through the gap L between the outlet side reflector 27 and the reactor main body member 23 on the outlet side.

As the base material of the reactor main body members 22 and 23 of the reactor and the base material of the reflectors 26 and 27, in place of a material such as stainless steel, nickel alloy steel, or nickel steel, which is catalytically active to O₂ or H₂ gas, a substantially different material that is catalytically inactive to O₂ or H₂ gas, that is, for example, an iron-chromium-aluminum alloy, an aluminum alloy, or a copper alloy, may be used.

In the case where the base materials of the reactor main body members 22 and 23 of the reactor are formed of a material, as described above, which is catalytically inactive, the outer surface of the noncatalytic material thereof on the portion other than the portion on which the Y₂O₃ barrier layer 28c is provided inside the internal space is preferably subjected to an appropriate surface treatment for preventing external release of the internal gas, or the internal metal composition material. As the surface treatment, a barrier layer may be formed that is noncatalytic and that has excellent resistance to corrosion, resistance to reduction, and resistance to oxidation. As such a barrier layer, TiN, TiC, TiCN, TiAlN, Al₂O₃, Cr₂O₃, SiO₂, or CrN may be used, and Y₂O₃ as well may be used. In addition, two or more types of those among these listed materials may be used together. In this case as well, in the case where a Y₂O₃ barrier layer is used as the surface treatment, the barrier layer may be used in common as the above-described barrier layer that inhibits impurities in the base material from diffusing inside the platinum catalyst layer 28b. The reflectors 26 and 27 as well are preferably subjected to the same surface treatment described above.

The Y₂O₃ barrier layer may be appropriately formed by a sol-gel process. For example, the base material of the reactor main body, formed of stainless steel or the like, may be coated with an organic solvent solution of yttrium alkoxide by spin coating, dip coating, spray coating, or the like, and after the coated film is dried, the film is fired at 500 to 600° C. for 1 to 5 hours in an oxygen atmosphere to form the Y₂O₃ barrier layer. In addition, a TiN, TiC, TiCN, TiAlN, Al₂O₃, Cr₂O₃, SiO₂, or CrN barrier layer may be formed to be 0.1 to 5 μm thick by use of a PVD method, such as an ion plating method, a sputtering method, or a vacuum deposition method, a chemical vapor deposition method (CVD method), a hot-pressing method, a thermal spraying technique, or the like.

In a case where the Y₂O₃ barrier layer is formed by a wet process, such as the above-described sol-gel process, because a coating film provided with a film thickness of approximately 50 nm may be obtained by one coating and firing, coating and firing are repeated several times as needed so as to make a desired film thickness (for example, 100 nm, 300 nm).

In order to improve the barrier performance regarding preventing impurities in the stainless steel base material from diffusing in the platinum catalyst layer, the film thickness of the barrier layer may be preferably thicker. However, a dense film free of defects, such as pinholes, is formed with precisely controlled particle diameters of the raw material, and the process of film formation of the Y₂O₃ barrier layer is able to obtain an equivalent barrier performance with a film thickness that is thinner than that of a conventional TiN barrier layer. In view of the increase in cost due to increases in the number of times of coating and firing to produce a thicker Y₂O₃ barrier layer, the film thickness of the Y₂O₃ barrier layer is preferably 300 nm or less.

On the other hand, because yttrium is an expensive material, it is preferable that the film thickness of the Y₂O₃ barrier layer is further reduced to achieve a reduction in cost. However, when the film thickness of the Y₂O₃ barrier layer is too thin, the barrier performance may be degraded, and it is difficult to control the film thickness. Therefore, although the film thickness of the Y₂O₃ barrier layer is usually 100 nm or more, it is possible to adequately fulfill the barrier function with a film thickness of 50 nm or more.

In addition, the Y₂O₃ barrier layer is preferably formed by a sol-gel process from the standpoint of reducing the cost of manufacturing facilities. However, the method is not limited thereto, and the Y₂O₃ barrier layer may be formed by a thermal spraying technique, a PVD method, a vacuum deposition method, a sputtering method, an ion plating method, or the like. By a dry process, such as a thermal spraying technique, it is possible to increase the film thickness of the Y₂O₃ barrier layer without repeating the same processes as in the wet process. However, even in the case of a dry process, in view of the material cost, the film thickness of the Y₂O₃ barrier layer is preferably 5 μm or less.

A platinum catalyst layer is formed on the Y₂O₃ barrier layer. The platinum catalyst layer may be formed by a vacuum deposition method, an ion plating method, a sputtering method, a chemical vapor deposition method, a hot-pressing method, or the like.

The film thickness of the platinum catalyst layer is preferably 0.1 μm to 3 μm (100 nm to 3000 nm). That is, when the film thickness is too thin, the platinum catalyst layer is unable to adequately perform both the function as a catalyst and the function as a protective film. Therefore, the film thickness of the platinum catalyst layer is preferably 0.1 μm (100 nm) or more. On the other hand, in view of the function as a catalyst and the function as a protective film of the barrier layer, as will be described later, the film thickness of the platinum catalyst layer is preferably increased. However, when the film thickness is too thick, the cost thereof is increased. Therefore, the film thickness of the platinum catalyst layer is preferably 3 μm (3000 nm) or less, and is more preferably 0.5 μm (500 nm) or less.

### EXAMPLES

The adhesion strength of the platinum catalyst layer to the Y₂O₃ barrier layer was tested according to the following procedure.

### Example 1

First, a circular substrate made of SUS316L (35 mm in diameter×3 mm in thickness) was prepared. A Y₂O₃ coating material (YYK01LBY-03: Brown liquid) manufactured by Kojundo Chemical Lab. Co., Ltd. was sprayed and coated onto the substrate by a spray nozzle, and was dried. Thereafter, this Y₂O₃ coating was subjected to heat treatment (firing) at 500° C. for one hour in an oxidant atmosphere at an O₂/N₂ ratio of 20%. A Y₂O₃ film, with a film thickness of approximately 50 nm, was formed by a one-time coating and heating treatment, and a Y₂O₃ barrier layer with a film thickness of approximately 100 nm was formed by repeating the coating and heating treatments twice.

Next, a platinum catalyst layer was formed on the Y₂O₃ barrier layer by use of an ion plating apparatus (AAIF-T12100SB series manufactured by Shinko Seiki Co., Ltd.) as follows.

That is, after any oxidized film, and the like, formed on the surface of the Y₂O₃ barrier layer were removed by bombardment with argon ions (Ar bombardment), the platinum catalyst layer was formed by ion plating processing. The Ar bombardment was set under the conditions that an Ar flow rate was 260 sccm, a substrate bias was −1500V, and a processing time was 10 minutes. The platinum catalyst layer with a film thickness of 0.23 μm (230 nm) was formed using this process of film formation wherein the substrate bias was −500V, the ionized electrode was set at 50V, the film formation rate was 0.025 μm/min., and the EB voltage was 9 kV.

An adhesion strength test was carried out on the example of film formation described above. As a testing device, an adhesion tester (i.e., coating film adhesion strength tester; Type 0610 series, manufactured by COTEC Corporation) was used.

A dolly attached to the testing device was bonded to the platinum catalyst layer by use of a predetermined epoxy resin adhesive. While the sample, to which the dolly was bonded, was heated for 400 hours in an air atmosphere of 500° C. to increase the severity of the environment, peel strength measurement by the adhesion tester was carried out every 50 hours.

### Example 2

In the same way as in Example 1, a Y₂O₃ barrier layer with a film thickness of 0.3 μm (300 nm) was formed on a substrate, and a platinum catalyst layer with a film thickness of 0.23 μm (230 nm) was formed on the Y₂O₃ barrier layer, and an adhesion strength test by the adhesion tester was then carried out under the same conditions as in Example 1.

### Example 3

A sample, which is the same as that in Example 1 except for the point that the film thickness of the platinum catalyst layer is 0.28 μm (280 nm), was prepared.

A dolly attached to the testing device was bonded to the platinum catalyst layer by use of a predetermined epoxy resin adhesive. While the sample, to which the dolly was bonded, was heated for 1000 hours in an air atmosphere of 500° C., in order to increase the severity of the environment, peel strength measurement by the adhesion tester was carried out every 50 hours.

### Example 4

The same kind of sample as in Example 3 was used. A dolly attached to the testing device was bonded to the platinum catalyst layer by use of a predetermined epoxy resin adhesive. While the sample, to which the dolly was bonded, was heated for 1000 hours in an air atmosphere of 550° C. in order to increase the severity of the environment, peel strength measurement by the adhesion tester was carried out every 50 hours.

### Comparative Example

A TiN film was formed as the barrier layer in place of the Y₂O₃ film, and a platinum catalyst layer was formed on the TiN barrier layer in accordance with a comparative example. The TiN barrier layer was formed by use of a cathodic arc ion plating apparatus so as to have a film thickness of 3 μm. A platinum catalyst layer of 0.3 pm (300 nm) was formed on the TiN barrier layer by use of an ion plating apparatus (AAIF-T12100SB series manufactured by Shinko Seiki Co., Ltd.). In the same way as in Examples 1 to 3, while the sample was heated in an air atmosphere of 500° C. in order to accelerate the severity of the environment, the peel strength test by the adhesion tester was carried out.

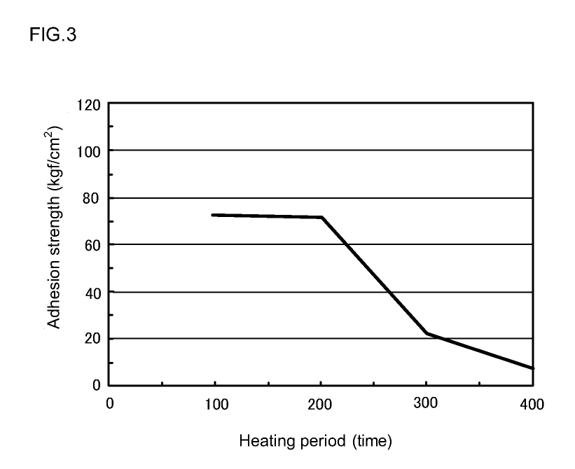

Graphs of the test results in the above-described examples and the comparative example are shown in FIGS. 1 to 3. FIG. 1 shows the test results for Examples 1 and 2, FIG. 2 shows the test results for Examples 3 and 4, and FIG. 3 shows the test result of the comparative example.

With reference to the graphs of FIGS. 1 to 3, the data shows that adhesion strength has remarkably, substantially deteriorated after an elapse of 200 hours in the comparative example. However, adhesion strength has hardly deteriorated even after an elapse of 400 hours in Examples 1 and 2, and adhesion strength is hardly deteriorated even after an elapse of 1000 hours in Examples 3 and 4. This substantial improvement in stability of the adhesion strength over time, achieved by the Examples 1, 2, 3 and 4 of the present invention (See FIGS. 1 and 2) over the comparative example (See FIG. 3) is an unexpected result.

By comparison between Example 1 and Example 2, there was no effect on adhesion strength even when the film thickness of the Y₂O₃ barrier layer was changed. However, by comparison between Example 1 and Example 3, from the fact that the platinum catalyst layer having the thicker film thickness in Example 3 maintains higher adhesion strength than Example 1, it is clear that a platinum catalyst layer having a thicker film thickness maintains higher adhesion strength. This may be because the vicinity of the interface between the Y₂O₃ barrier layer and the platinum catalyst layer is difficult to oxidize when the platinum catalyst layer is thicker. That is, the platinum catalyst layer may function as a protective film for protecting the Y₂O₃ barrier layer from oxidization as well. However, because adhesion strength between the platinum catalyst layer and the Y₂O₃ barrier layer is 5 kgf/cm² or more, no practical problem is caused by this difference in the thickness of the platinum catalyst layer. Because deterioration with time in adhesion strength of the Y₂O₃ barrier layer to the platinum catalyst layer is hardly found in the test results in Examples 1 to 4, from the standpoint of adhesion strength, no practical problem occurs when the film thickness of the Y₂O₃ barrier layer is 0.1 μm (100 nm) or more as in Example 1.

Furthermore, by comparison between the examples of the present invention and the comparative example, it is clear that even when the Y₂O₃ barrier layer had a film thickness (0.3 μm, 0.1 μm), which is less than or equal to 1/10^{th} of the film thickness of the TiN barrier layer (3 μm) of the comparative example, the Y₂O₃ barrier layers maintained their adhesion strengths higher than that of the much thicker TiN barrier layer. This result may be because the Y₂O₃ barrier layer is a stable substance whose standard Gibbs energy of formation is higher than that of the TiN barrier layer, and has excellent resistance to oxidation. Accordingly, by controlling the film thickness of a Y₂O₃ barrier layer even if yttrium, which is more expensive than titanium, is used, it is possible to form a Y₂O₃ barrier layer having more excellent adhesion strength performance at a cost equivalent to or less than that for a TiN barrier layer.

### DESCRIPTION OF SYMBOLS

22, 23: Reactor main body members
24: Raw material gas inlet
25: Moisture gas outlet
26: Inlet side reflector
27: Outlet side reflector
28a: Barrier layer (conventional)
28b: Platinum catalyst layer
28c: Y₂O₃ barrier layer
30: Fixation screws
31: Spacers

1. A reactor for moisture generation comprising:
(a) a reactor main body provided with an internal wall surface, and a gas inlet and a moisture outlet disposed on the internal wall surface;
(b) a Y₂O₃ barrier layer that is formed on at least a portion of the internal wall surface of the reactor main body; and
(c) a platinum catalyst layer formed on at least a portion of the Y₂O₃ barrier layer.

2. The reactor for moisture generation according to claim 1, wherein the Y₂O₃ barrier layer is a film having a thickness of 50 nm to 5 μ.

3. The reactor for moisture generation according to claim 1, wherein the reactor main body is formed of a material that is catalytically inactive to hydrogen and oxygen.

4. The reactor for moisture generation according to claim 1, further comprising:
(d) at least one reflector disposed inside the reactor main body, wherein the at least one reflector is formed of a material that is catalytically inactive to hydrogen and oxygen.

5. The reactor for moisture generation according to claim 4, wherein the at least one reflector is fixed to the reactor main body via spacers and fixation screws so as to block up at least one of the gas inlet and the moisture outlet via a predetermined space, and the spacers and the fixation screws are formed of a material that is catalytically inactive to hydrogen and oxygen.

6. The reactor for moisture generation according to claim 1, wherein the reactor main body includes reactor main body members and reflectors having surfaces exposed to gas inside the reactor, and the reactor main body members and the reflectors comprise a material that is catalytically inactive to hydrogen and oxygen.

7. The reactor for moisture generation according to claim 3, wherein the material that is catalytically inactive is an iron-chromium-aluminum alloy, an aluminum alloy, or a copper alloy.

8. The reactor for moisture generation according to claim 1, wherein an area of the reactor main body, other than a portion on which the platinum catalyst layer is provided inside an internal space defined by the internal wall of the reactor main body, is coated with a second barrier layer formed of a material that is catalytically inactive to hydrogen and oxygen.

9. The reactor for moisture generation according to claim 1, further comprising at least one reflector disposed inside the reactor main body, wherein the at least one reflector is coated with a second barrier layer formed of a material that catalytically inactive to hydrogen and oxygen.

10. The reactor for moisture generation according to claim 9, wherein the at least one reflector is fixed to the reactor main body via spacers and fixation screws so as to block up at least one of the gas inlet and the moisture outlet via a predetermined space, and the spacers and the fixation screws are coated with a third barrier layer formed of a material that is catalytically inactive to hydrogen and oxygen.

11. The reactor for moisture generation according to claim 8, wherein the second barrier layer formed of the material that is catalytically inactive comprises at least one material selected from the group consisting of TiN, TiC, TiCN, TiAlN, Al₂O₃, Cr₂O₃, SiO₂, CrN, and Y₂O₃.

12. The reactor for moisture generation according to claim 4, wherein the material that is catalytically inactive is an iron-chromium-aluminum alloy, an aluminum alloy, or a copper alloy.

13. The reactor for moisture generation according to claim 5, wherein the material that is catalytically inactive is an iron-chromium-aluminum alloy, an aluminum alloy, or a copper alloy.

14. The reactor for moisture generation according to claim 6, wherein the material that is catalytically inactive is an iron-chromium-aluminum alloy, an aluminum alloy, or a copper alloy.

15. The reactor for moisture generation according to claim 9, wherein the second barrier layer formed of the material that is catalytically inactive comprises at least one material selected from the group consisting of TiN, TiC, TiCN, TiAlN, Al₂O₃, Cr₂O₃, SiO₂, CrN, and Y₂O₃.

16. The reactor for moisture generation according to claim 10, wherein the second barrier layer formed of the material that is catalytically inactive comprises at least one material selected from the group consisting of TiN, TiC, TiCN, TiAlN, Al₂O₃, Cr₂O₃, SiO₂, CrN, and Y₂O₃.
